(19) United States
(12) Patent Application Publication
(10) Pub. No.: US 2012/0169248 A1
(43) Pub. Date: Jul. 5, 2012

(54) SMART DIMMABLE POWER SUPPLY APPARATUS FOR ENERGY SAVING LAMP AND METHOD FOR THE SAME

(75) Inventor: Jiun-Chau TZENG, Taipei City (TW)

(73) Assignees: Advanpower International Limited; Hsiu-Yu Hsu

(21) Appl. No.: 13/042,105

(22) Filed: Mar. 7, 2011

(30) Foreign Application Priority Data
Jan. 5, 2011 (TW) 100100358
Jan. 20, 2011 (TW) 100102051

(51) Int. Cl. H05B 37/02

(52) U.S. Cl. 315/291

(57) ABSTRACT

A smart dimmable power supply apparatus for energy saving lamp (10) includes an input terminal (102), a power transforming unit (104), a power output terminal (106), a dimming signal interface unit (108), and a dimming signal detection identification and power transforming control unit (110). The dimming signal detection identification and power transforming control unit (110) includes a power transforming control subunit (116), a dimming signal identification subunit (118), a first dimming signal detection control subunit, and a second dimming signal detection control subunit. The smart dimmable power supply apparatus for energy saving lamp (10) can automatically detect the kind of the dimmer and dimming method to supply power and dim to an energy saving lamp.

### BACKGROUND OF THE INVENTION

1. Field of the Invention

The present invention relates to a power supply apparatus for energy saving lamp and method for the same, and in particular to a smart dimmable power supply apparatus for energy saving lamp and method for the same.

2. Description of Prior Art

In the near future, incandescent lamps will be replaced by energy saving lamps (for example fluorescent lamps or light emitting diode lamps). For these energy saving lamps, the power supply apparatus for fluorescent lamps is generally called ballast. The power supply apparatus for light emitting diode lamps is generally called driver.

Dimming is an important function for energy saving lamps, because dimming can help to save power. There are many dimming methods for energy saving lamps sold in the market now, for example triac type, 0˜10 voltage type, and on-off type.

A user can dim an energy saving lamp after a triac type power supply apparatus is connected to a triac type dimmer. A user can dim an energy saving lamp after a 0˜10 voltage type power supply apparatus is connected to a 0˜10 voltage type dimmer. When a user dim an energy saving lamp by an on-off type power supply apparatus, the energy saving lamp is dimmed by the on-off type power supply apparatus with the on-off times of the power switch. The on-off type power supply apparatus is not required to connect to a dimmer.

Therefor different dimmers (dimming types) will require different power supply apparatuses of energy saving lamps. This will cause inconvenience for manufacturers of power supply apparatuses of energy saving lamps and for users.

### SUMMARY OF THE INVENTION

In order to solve the above-mentioned problems, an object of the present invention is to provide a smart dimmable power supply apparatus for energy saving lamp, to adapt to various dimmers and dimming types.

In order to solve the above-mentioned problems, another object of the present invention is to provide a smart dimmable power supply method for energy saving lamp, to adapt to various dimmers and dimming types.

In order to solve the above-mentioned problems, another object of the present invention is to provide a smart dimmable power supply method for energy saving lamp, to adapt to various dimmers and dimming types.

In order to achieve the object of the present invention mentioned above, the smart dimmable power supply apparatus for energy saving lamp of the present invention includes an input terminal, a power transforming unit, a power output terminal, a dimming signal interface unit, and a dimming signal detection identification and power transforming control unit. The power transforming unit is electrically connected to the input terminal. The power output terminal is electrically connected to the power transforming unit. The dimming signal interface unit is electrically connected to the input terminal. The dimming signal detection identification and power transforming control unit is electrically connected to the dimming signal interface unit and the power transforming unit. The dimming signal detection identification and power transforming control unit includes a power transforming control subunit, a dimming signal identification subunit, a first dimming signal detection control subunit, and a second dimming signal detection control subunit. The power transforming control subunit is electrically connected to the power transforming unit. The dimming signal identification subunit is electrically connected to the power transforming control subunit. The first dimming signal detection control subunit is electrically connected to the dimming signal identification subunit. The second dimming signal detection control subunit is electrically connected to the dimming signal identification subunit.

In order to achieve another object of the present invention mentioned above, the smart dimmable power supply method for energy saving lamp of the present invention includes following steps. A dimming signal is received by a triac dimming signal interface subunit. The dimming signal received by the triac dimming signal interface subunit is detected by a triac dimming signal detection subunit. A power transforming unit is controlled by a power transforming control subunit with triac dimming method to supply power and dim to an energy saving lamp if the dimming signal received by the triac dimming signal interface subunit and detected by the triac dimming signal detection subunit includes a triac dimming signal judged by a dimming signal identification subunit. The dimming signal is received by a 0˜10 voltage dimming signal interface subunit. The dimming signal received by the 0˜10 voltage dimming signal interface subunit is detected by a 0˜10 voltage dimming signal detection subunit. The power transforming unit is controlled by the power transforming control subunit with 0˜10 voltage dimming method to supply power and dim to the energy saving lamp if the dimming signal received by the 0˜10 voltage dimming signal interface subunit and detected by the 0˜10 voltage dimming signal detection subunit includes a 0˜10 voltage dimming signal judged by the dimming signal identification subunit.

In order to achieve another object of the present invention mentioned above, the smart dimmable power supply method for energy saving lamp of the present invention includes following steps. A dimming signal is received by a first dimming signal interface subunit. The dimming signal received by the first dimming signal interface subunit is detected by a first dimming signal detection subunit. A power transforming unit is controlled by a power transforming control subunit with first dimming method to supply power and dim to an energy saving lamp if the dimming signal received by the first dimming signal interface subunit and detected by the first dimming signal detection subunit includes a first dimming signal judged by a dimming signal identification subunit. The power transforming unit is controlled by the power transforming control subunit with on-off dimming method to supply power and dim to the energy saving lamp if the dimming signal received by the first dimming signal interface subunit and detected by the first dimming signal detection subunit does not include the first dimming signal judged by the dimming signal identification subunit.

The efficiency of the present invention is to automatically detect the kind of the dimmer and dimming method to supply power and dim to an energy saving lamp.

### BRIEF DESCRIPTION OF DRAWING

FIG. 1 shows a block diagram of the first embodiment of the smart dimmable power supply apparatus for energy saving lamp of the present invention.

FIG. 2 shows a block diagram of the second embodiment of the smart dimmable power supply apparatus for energy saving lamp of the present invention.

FIG. 3 shows a block diagram of the third embodiment of the smart dimmable power supply apparatus for energy saving lamp of the present invention.

FIG. 4 shows a block diagram of the fourth embodiment of the smart dimmable power supply apparatus for energy saving lamp of the present invention.

FIG. 5 shows a flow chart of the first embodiment of the smart dimmable power supply method for energy saving lamp of the present invention.

FIG. 6 shows a flow chart of the second embodiment of the smart dimmable power supply method for energy saving lamp of the present invention.

FIG. 7 shows a flow chart of the third embodiment of the smart dimmable power supply method for energy saving lamp of the present invention.

FIG. 8 shows a flow chart of the fourth embodiment of the smart dimmable power supply method for energy saving lamp of the present invention.

FIG. 9A shows a part of the circuit diagram of an embodiment of the first embodiment applied to light emitting diode lamps of the smart dimmable power supply apparatus for energy saving lamp of the present invention.

FIG. 9B shows another part of the circuit diagram of an embodiment of the first embodiment applied to light emitting diode lamps of the smart dimmable power supply apparatus for energy saving lamp of the present invention.

FIG. 10A shows a part of the circuit diagram of an embodiment of the first embodiment applied to fluorescent lamps of the smart dimmable power supply apparatus for energy saving lamp of the present invention.

FIG. 10B shows another part of the circuit diagram of an embodiment of the first embodiment applied to fluorescent lamps of the smart dimmable power supply apparatus for energy saving lamp of the present invention.

FIG. 11A shows a part of the circuit diagram of an embodiment of the second embodiment applied to light emitting diode lamps of the smart dimmable power supply apparatus for energy saving lamp of the present invention.

FIG. 11B shows another part of the circuit diagram of an embodiment of the second embodiment applied to light emitting diode lamps of the smart dimmable power supply apparatus for energy saving lamp of the present invention.

FIG. 12A shows a part of the circuit diagram of an embodiment of the second embodiment applied to fluorescent lamps of the smart dimmable power supply apparatus for energy saving lamp of the present invention.

FIG. 12B shows another part of the circuit diagram of an embodiment of the second embodiment applied to fluorescent lamps of the smart dimmable power supply apparatus for energy saving lamp of the present invention.

FIG. 13A shows a part of the circuit diagram of an embodiment of the third embodiment applied to light emitting diode lamps of the smart dimmable power supply apparatus for energy saving lamp of the present invention.

FIG. 13B shows another part of the circuit diagram of an embodiment of the third embodiment applied to light emitting diode lamps of the smart dimmable power supply apparatus for energy saving lamp of the present invention.

FIG. 14A shows a part of the circuit diagram of an embodiment of the third embodiment applied to fluorescent lamps of the smart dimmable power supply apparatus for energy saving lamp of the present invention.

FIG. 14B shows another part of the circuit diagram of an embodiment of the third embodiment applied to fluorescent lamps of the smart dimmable power supply apparatus for energy saving lamp of the present invention.

FIG. 15A shows a part of the circuit diagram of an embodiment of the fourth embodiment applied to light emitting diode lamps of the smart dimmable power supply apparatus for energy saving lamp of the present invention.

FIG. 15B shows another part of the circuit diagram of an embodiment of the fourth embodiment applied to light emitting diode lamps of the smart dimmable power supply apparatus for energy saving lamp of the present invention.

FIG. 16A shows a part of the circuit diagram of an embodiment of the fourth embodiment applied to fluorescent lamps of the smart dimmable power supply apparatus for energy saving lamp of the present invention.

FIG. 16B shows another part of the circuit diagram of an embodiment of the fourth embodiment applied to fluorescent lamps of the smart dimmable power supply apparatus for energy saving lamp of the present invention.

### DETAILED DESCRIPTION OF THE INVENTION

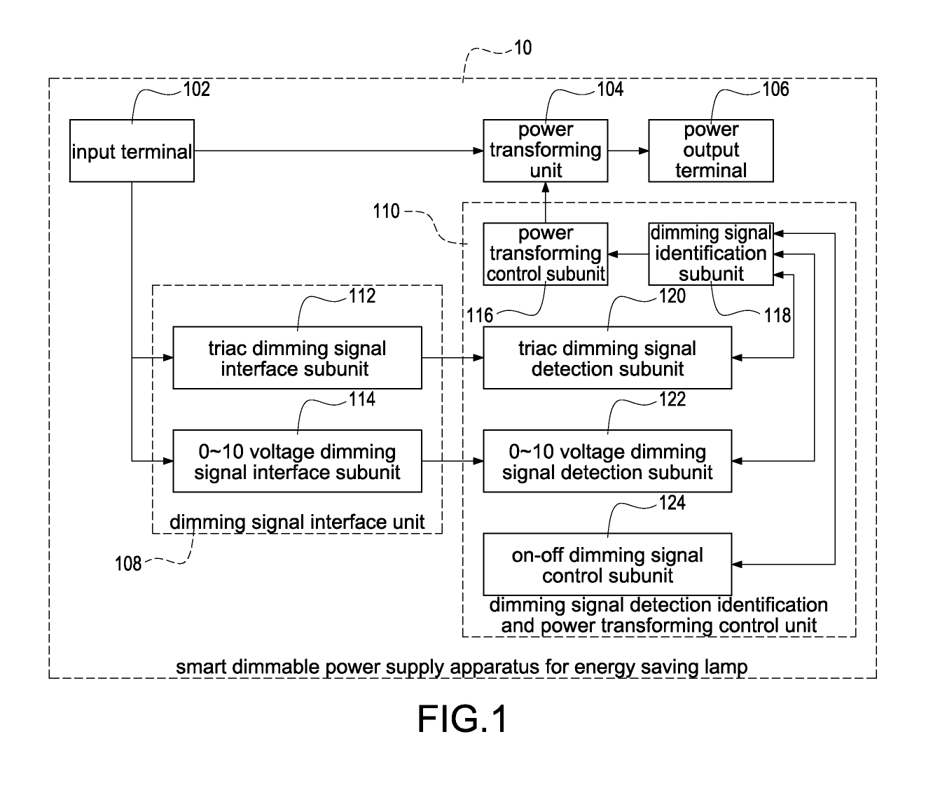

FIG. 1 shows a block diagram of the first embodiment of the smart dimmable power supply apparatus for energy saving lamp of the present invention. A smart dimmable power supply apparatus for energy saving lamp 10 of the present invention includes an input terminal 102, a power transforming unit 104, a power output terminal 106, a dimming signal interface unit 108, and a dimming signal detection identification and power transforming control unit 110.

The power transforming unit 104 is electrically connected to the input terminal 102. The power output terminal 106 is electrically connected to the power transforming unit 104. The dimming signal interface unit 108 is electrically connected to the input terminal 102. The dimming signal detection identification and power transforming control unit 110 is electrically connected to the dimming signal interface unit 108 and the power transforming unit 104. The power output terminal 106 is electrically connected to an energy saving lamp (not shown in the FIG. 1).

The dimming signal interface unit 108 includes a triac dimming signal interface subunit 112 and a 0˜10 voltage dimming signal interface subunit 114. The triac dimming signal interface subunit 112 is electrically connected to the input terminal 102 and the dimming signal detection identification and power transforming control unit 110. The 0˜10 voltage dimming signal interface subunit 114 is electrically connected to the input terminal 102 and the dimming signal detection identification and power transforming control unit 110.

The dimming signal detection identification and power transforming control unit 110 includes a power transforming control subunit 116, a dimming signal identification subunit 118, a triac dimming signal detection subunit 120, a 0˜10 voltage dimming signal detection subunit 122, and an on-off dimming signal control subunit 124.

The power transforming control subunit 116 is electrically connected to the power transforming unit 104. The dimming signal identification subunit 118 is electrically connected to the power transforming control subunit 116. The triac dimming signal detection subunit 120 is electrically connected to the dimming signal identification subunit 118 and the triac dimming signal interface subunit 112. The 0˜10 voltage dimming signal detection subunit 122 is electrically connected to the dimming signal identification subunit 118 and the 0˜10 voltage dimming signal interface subunit 114. The on-off dimming signal control subunit 124 is electrically connected to the dimming signal identification subunit 118.

If the smart dimmable power supply apparatus for energy saving lamp 10 is applied to a triac type dimmer (not shown in the FIG. 1), the input terminal 102 is electrically connected to the triac type dimmer. The triac type dimmer is electrically connected to a power source (not shown in the FIG. 1).

If the smart dimmable power supply apparatus for energy saving lamp 10 is applied to a 0˜10 voltage type dimmer (not shown in the FIG. 1), the input terminal 102 is electrically connected to the 0˜10 voltage type dimmer. The 0˜10 voltage type dimmer is electrically connected to the power source.

If on-off type dimming method is used by a user (a dimmer is not required), the input terminal 102 is electrically connected to a power switch (not shown in the FIG. 1). The power switch is electrically connected to the power source.

The triac dimming signal detection subunit 120 may include an analog-digital converter (not shown in the FIG. 1). The 0˜10 voltage dimming signal detection subunit 122 may include an analog-digital converter (not shown in the FIG. 1). The on-off dimming signal control subunit 124 may include a memory subunit (not shown in the FIG. 1) to record the on-off times of the power switch. The power transforming control subunit 116 may include a pulse width modulator (not shown in the FIG. 1) to send out a pulse width modulation output power control signal. The dimming signal identification subunit 118 may be a microcontroller (not shown in the FIG. 1) or a digital circuit (not shown in the FIG. 1).

The input terminal 102 is used to receive a dimming signal or the power source. The power transforming unit 104 is used to transform the power source into a power adapted to the energy saving lamp. The power transforming unit 104 receives an output power control signal sent out by the power transforming control subunit 116 of the dimming signal detection identification and power transforming control unit 110 to control the output power of the power adapted to the energy saving lamp.

The dimming signal interface unit 108 receives various dimming signals. For example, the triac dimming signal interface subunit 112 receives dimming signals sent from the triac type dimmer. For example, the 0˜10 voltage dimming signal interface subunit 114 is used to receive dimming signals sent from the 0˜10 voltage type dimmer.

The dimming signal detection identification and power transforming control unit 110 is used to detect the dimming signals received by the dimming signal interface unit 108, and judge the type of the dimmer electrically connected to the input terminal 102. According to this, the dimming signal detection identification and power transforming control unit 110 decides the dimming method for the energy saving lamp. The output power control signal is sent from the power transforming control subunit 116 to the power transforming unit 104.

For example, the dimming signal sent from the triac type dimmer and received by the triac dimming signal interface subunit 112 is detected by the triac dimming signal detection subunit 120. According to this, the dimming signal identification subunit 118 judges the dimmer electrically connected to the input terminal 102 is the triac type dimmer. According to this, the dimming signal detection identification and power transforming control unit 110 decides to dim the energy saving lamp with triac dimming method.

For example, the dimming signal sent from the 0˜10 voltage type dimmer and received by the 0˜10 voltage dimming signal interface subunit 114 is detected by the 0˜10 voltage dimming signal detection subunit 122. Accordingly, the dimming signal identification subunit 118 judges the dimmer electrically connected to the input terminal 102 is the 0˜10 voltage type dimmer. Accordingly, the dimming signal detection identification and power transforming control unit 110 decides to dim the energy saving lamp with 0˜10 voltage dimming method.

When the dimming signal sent from the triac type dimmer and received by the triac dimming signal interface subunit 112 is not detected by the triac dimming signal detection subunit 120, and when the dimming signal sent from the 0˜10 voltage type dimmer and received by the 0˜10 voltage dimming signal interface subunit 114 is not detected by the 0˜10 voltage dimming signal detection subunit 122, the dimming signal detection identification and power transforming control unit 110 decides to dim the energy saving lamp with on-off dimming method.

The dimming methods applied to the present invention are not limited to the triac dimming method, the 0˜10 voltage dimming method, and the on-off dimming method mentioned above. The dimming methods applied to the present invention further include other dimming methods, for example, the sine wave dimming method. The triac dimming signal detection subunit 120 can use the phase detection technology or the average voltage detection technology. When the triac dimming signal detection subunit 120 uses the average voltage detection technology, the triac dimming signal detection subunit 120 is able to detect triac dimming signals or sine wave dimming signals.

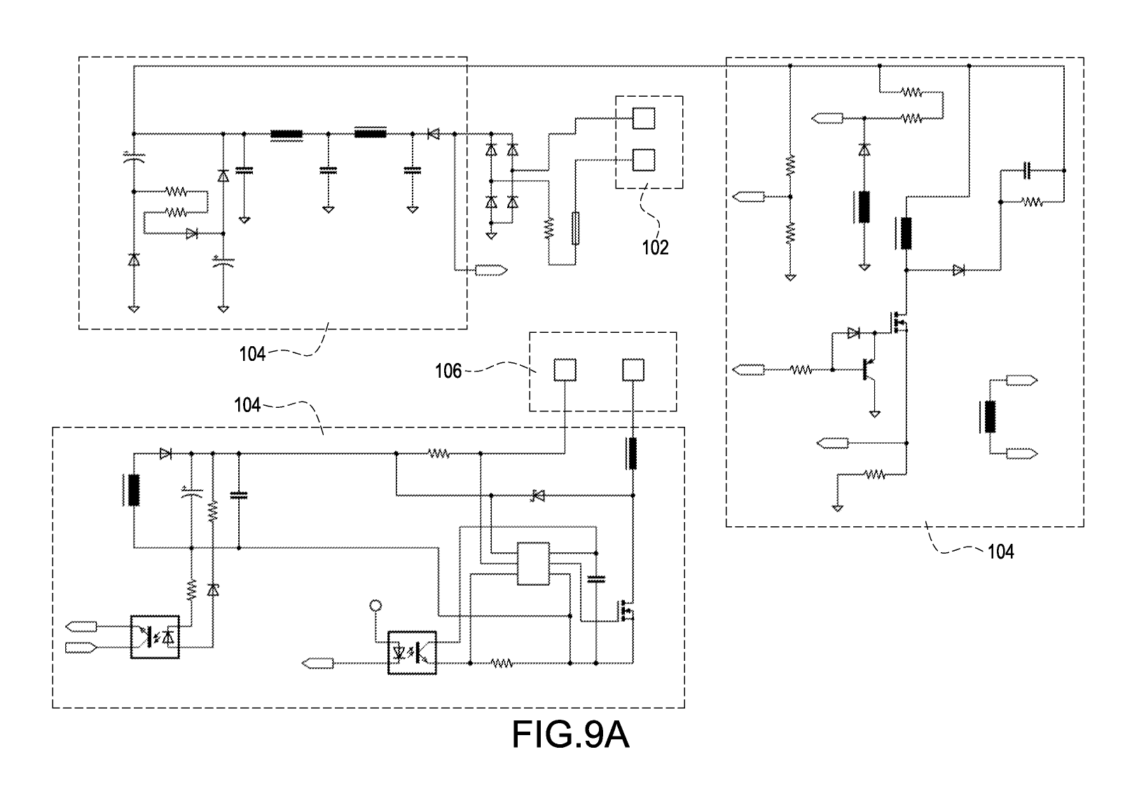

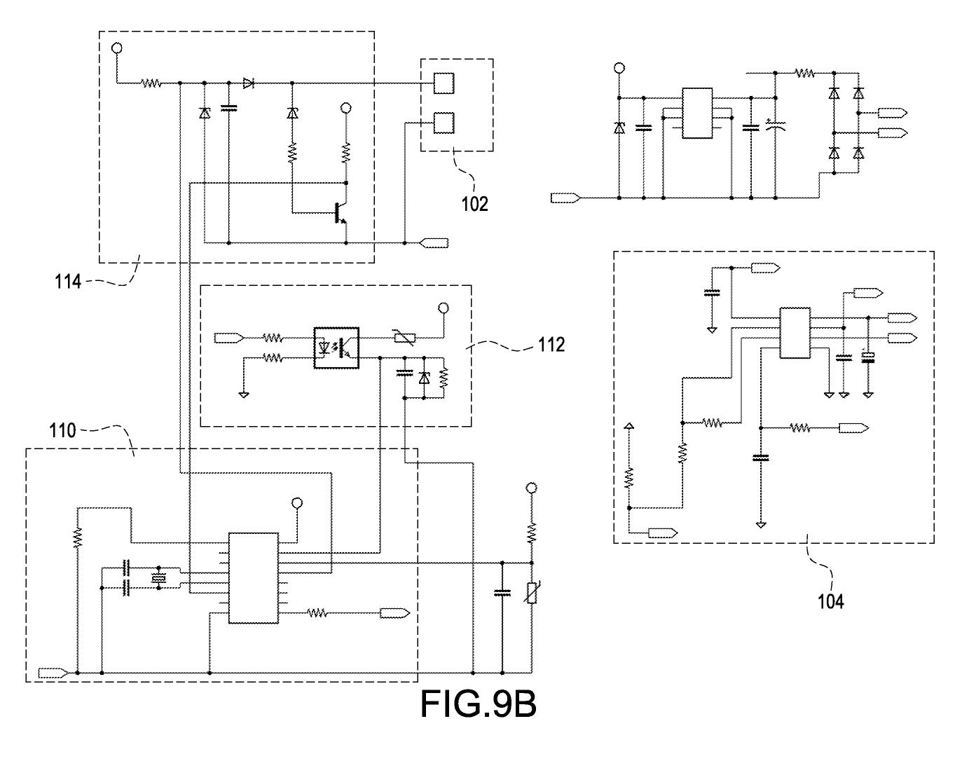

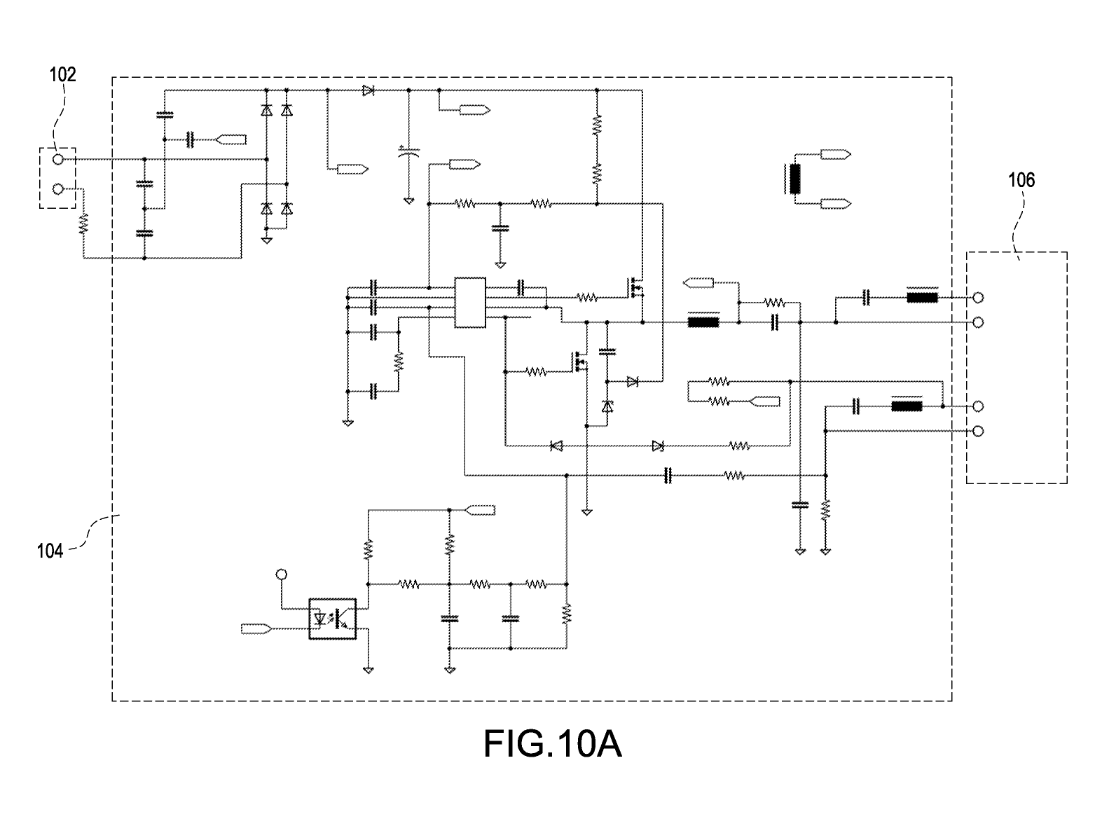

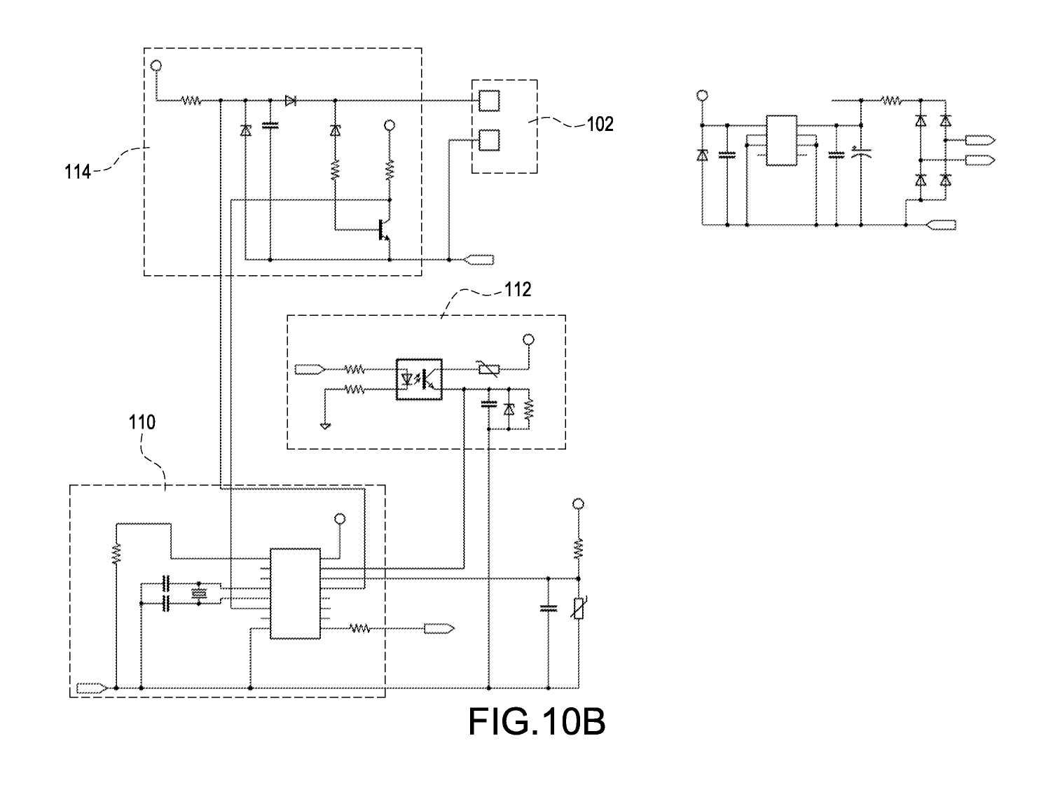

FIG. 9A shows a part of the circuit diagram of an embodiment of the first embodiment applied to light emitting diode lamps of the smart dimmable power supply apparatus for energy saving lamp of the present invention. FIG. 9B shows another part of the circuit diagram of an embodiment of the first embodiment applied to light emitting diode lamps of the smart dimmable power supply apparatus for energy saving lamp of the present invention. FIG. 10A shows a part of the circuit diagram of an embodiment of the first embodiment applied to fluorescent lamps of the smart dimmable power supply apparatus for energy saving lamp of the present invention. FIG. 10B shows another part of the circuit diagram of an embodiment of the first embodiment applied to fluorescent lamps of the smart dimmable power supply apparatus for energy saving lamp of the present invention.

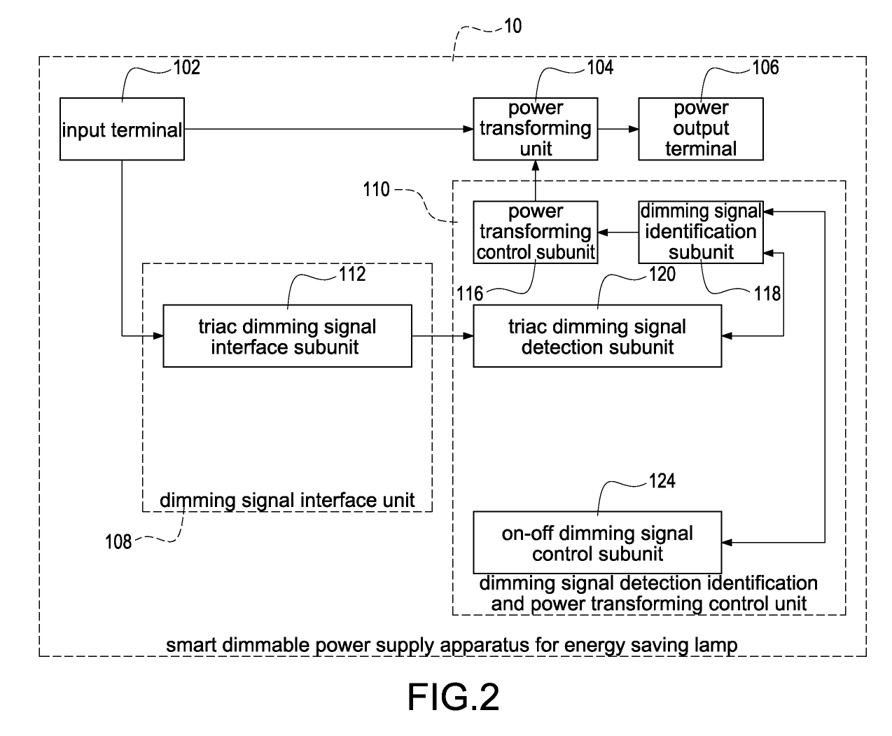

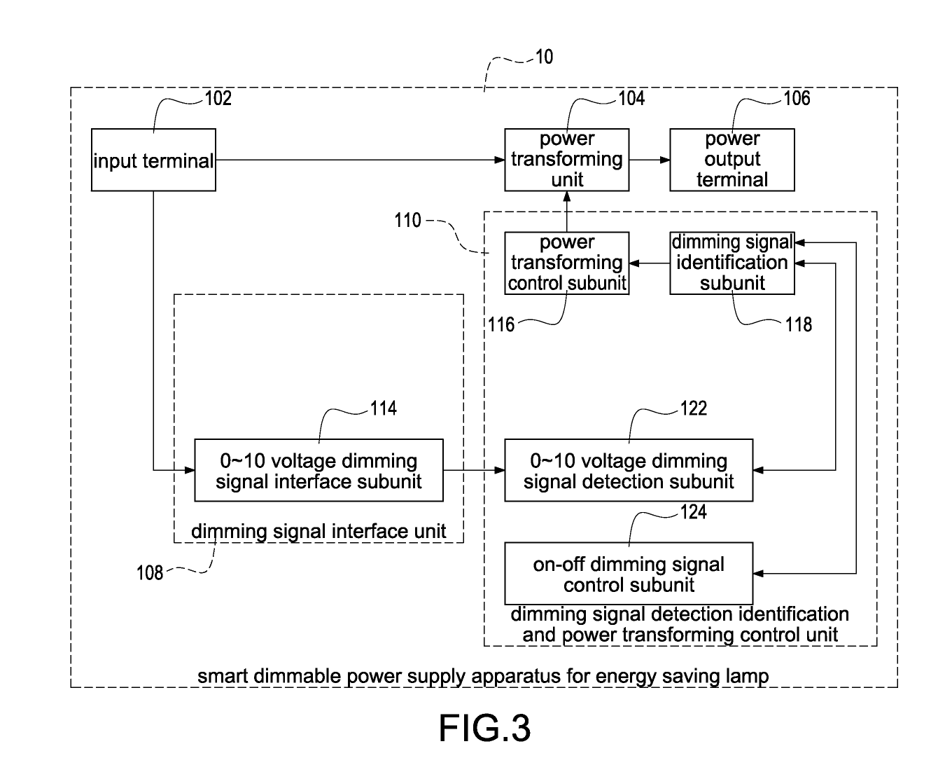

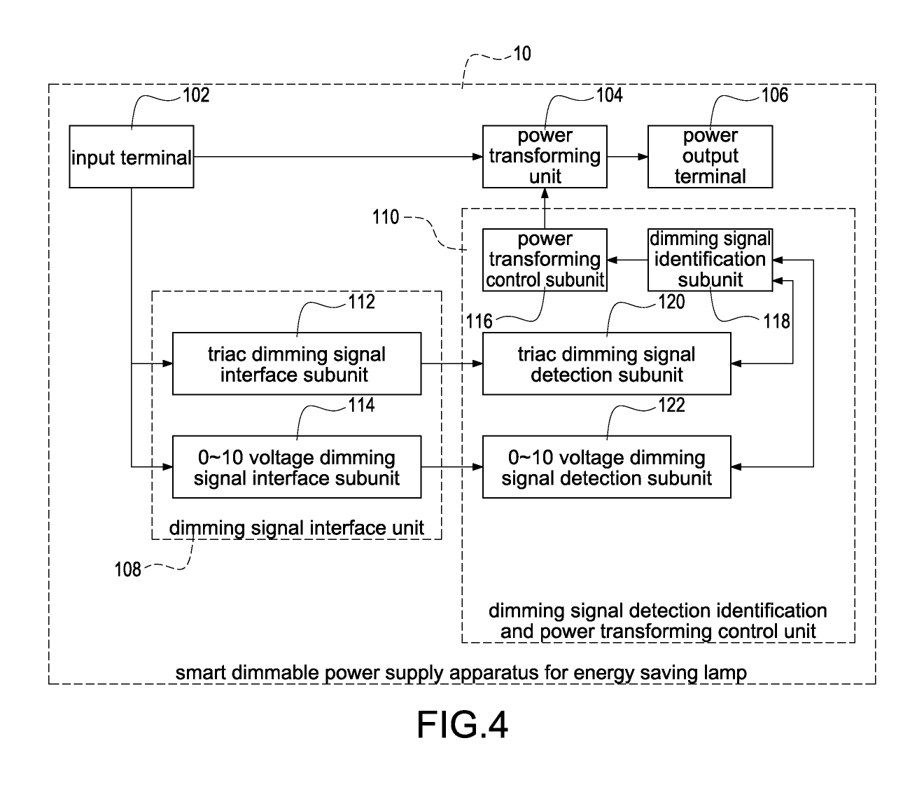

The smart dimmable power supply apparatus for energy saving lamp 10 shown in the FIG. 1 is applied to the triac dimming method, the 0˜10 voltage dimming method, and the on-off dimming method. The present invention is able to be applied to only the triac dimming method and the on-off dimming method (as FIG. 2). The present invention is able to be applied to only the 0˜10 voltage dimming method and the on-off dimming method (as FIG. 3). The present invention is able to be applied to only the triac dimming method and the 0˜10 voltage dimming method (as FIG. 4).

FIG. 2 shows a block diagram of the second embodiment of the smart dimmable power supply apparatus for energy saving lamp of the present invention. FIG. 3 shows a block diagram of the third embodiment of the smart dimmable power supply apparatus for energy saving lamp of the present invention. FIG. 4 shows a block diagram of the fourth embodiment of the smart dimmable power supply apparatus for energy saving lamp of the present invention. The circuit blocks and working principles of the second embodiment shown in the FIG. 2, the third embodiment shown in the FIG. 3, and the fourth embodiment shown in the FIG. 4 are similar to the first embodiment shown in the FIG. 1. The details are omitted here for conciseness.

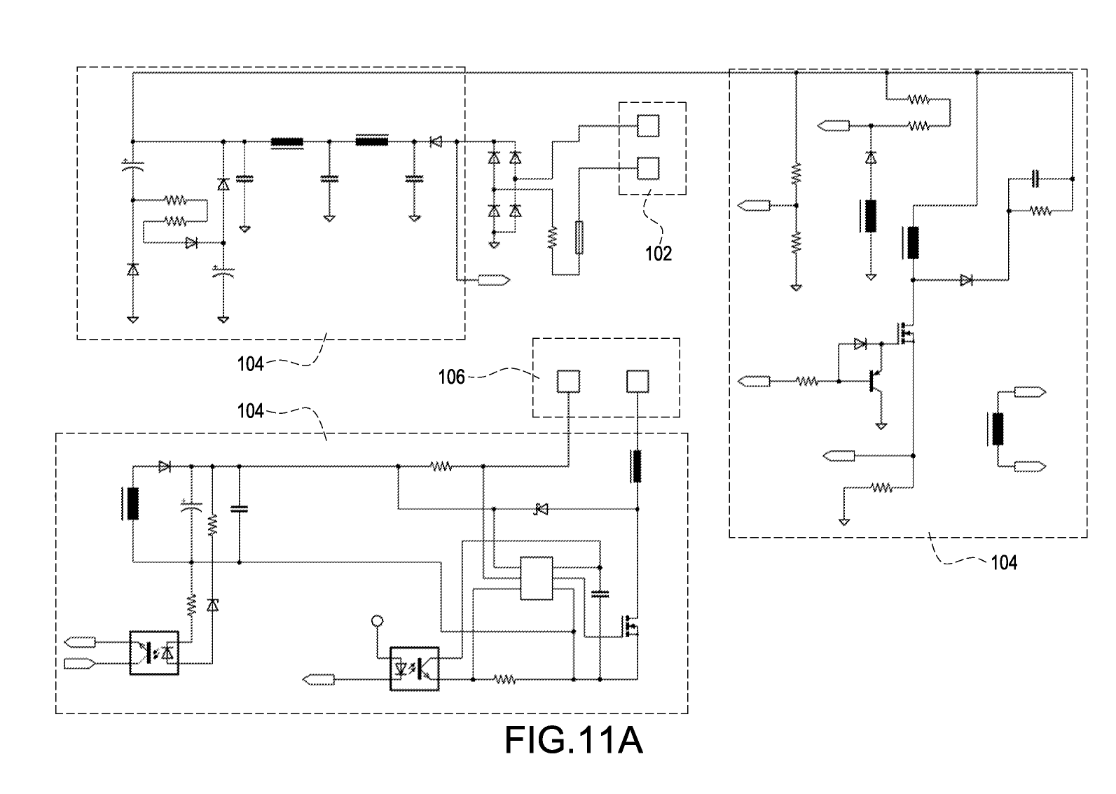

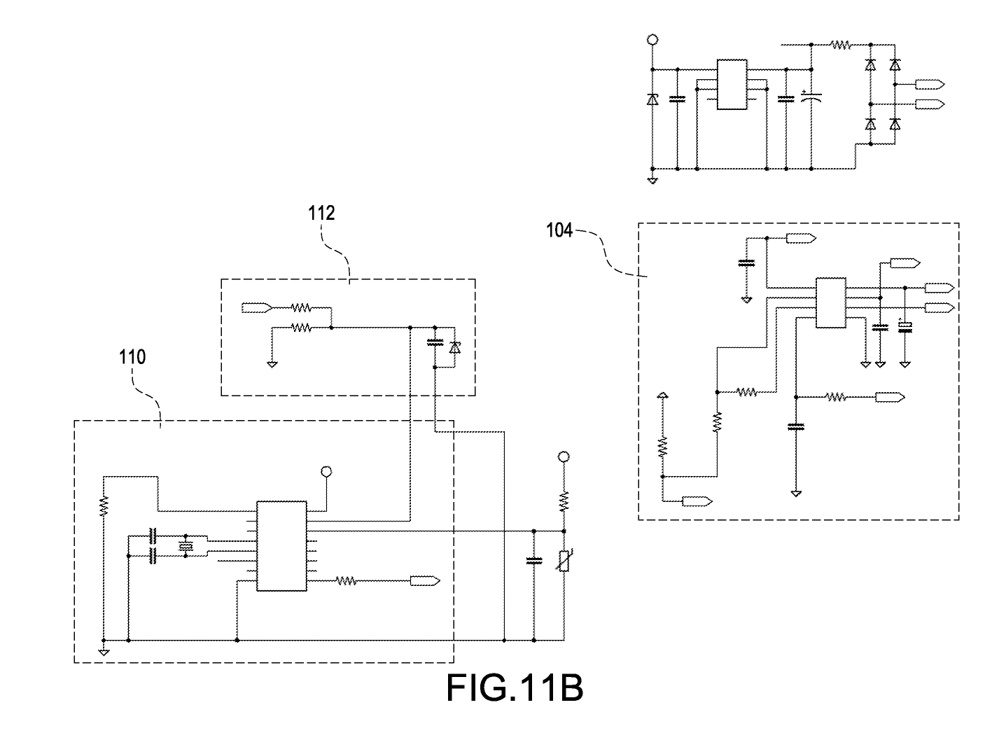

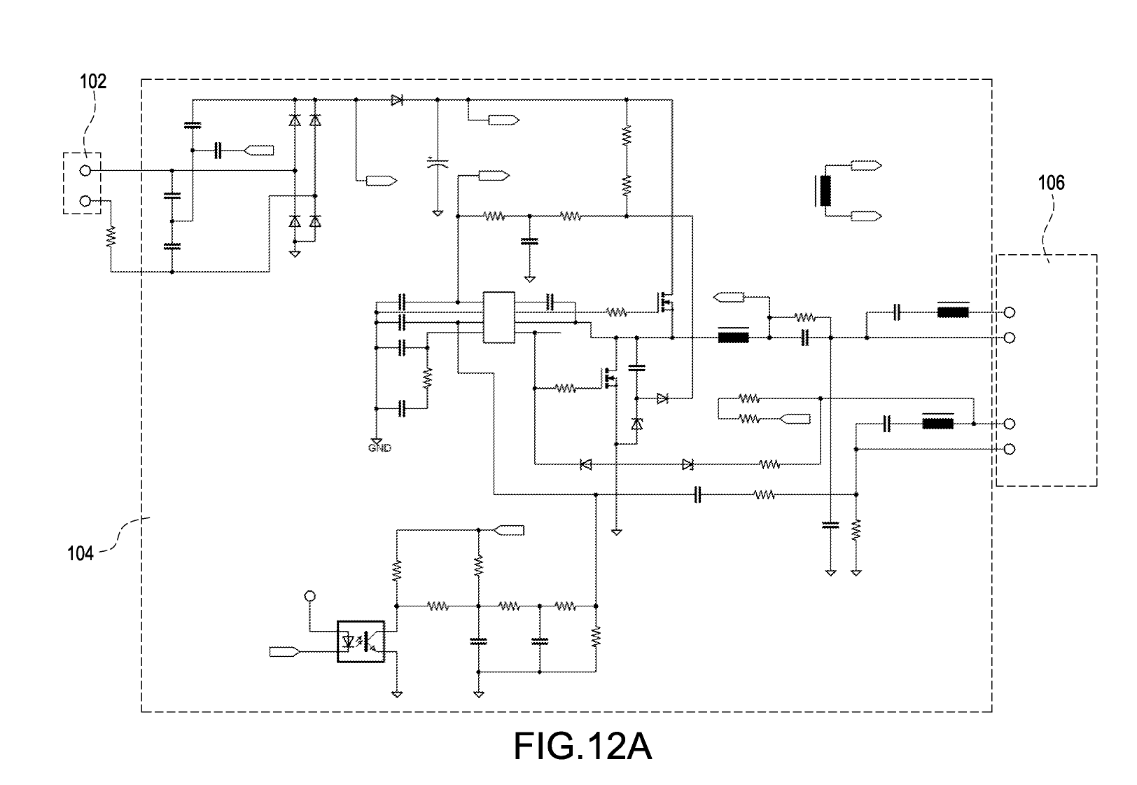

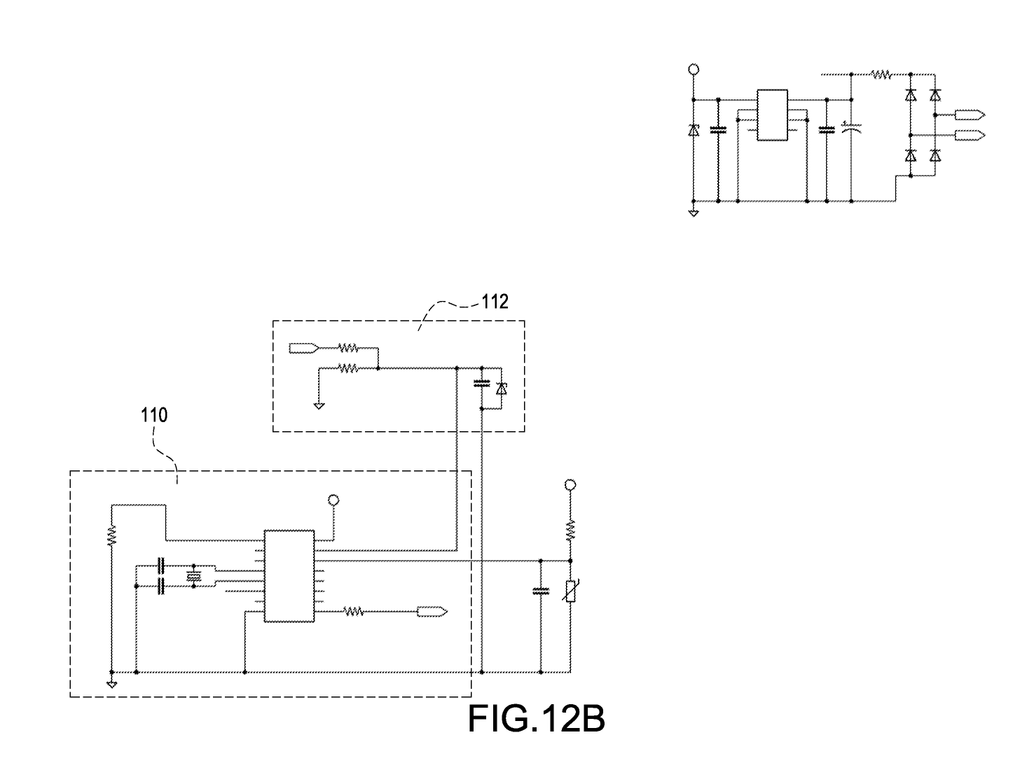

FIG. 11A shows a part of the circuit diagram of an embodiment of the second embodiment applied to light emitting diode lamps of the smart dimmable power supply apparatus for energy saving lamp of the present invention. FIG. 11B shows another part of the circuit diagram of an embodiment of the second embodiment applied to light emitting diode lamps of the smart dimmable power supply apparatus for energy saving lamp of the present invention. FIG. 12A shows a part of the circuit diagram of an embodiment of the second embodiment applied to fluorescent lamps of the smart dimmable power supply apparatus for energy saving lamp of the present invention. FIG. 12B shows another part of the circuit diagram of an embodiment of the second embodiment applied to fluorescent lamps of the smart dimmable power supply apparatus for energy saving lamp of the present invention.

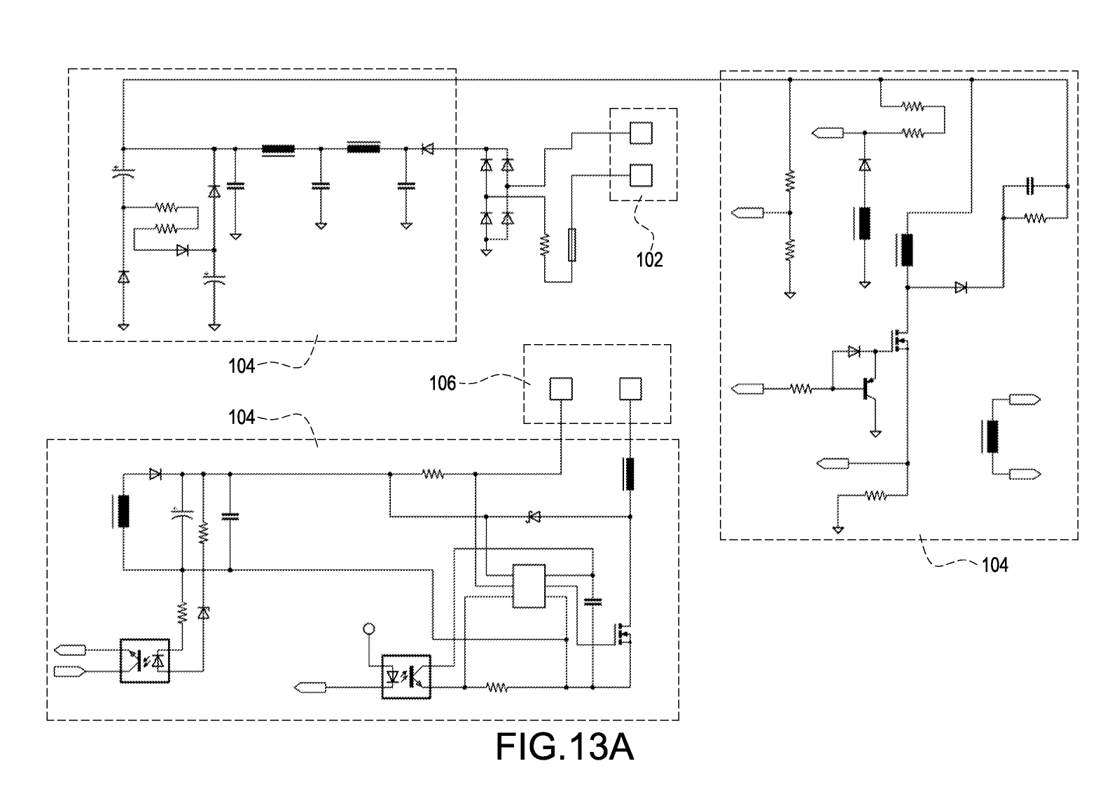

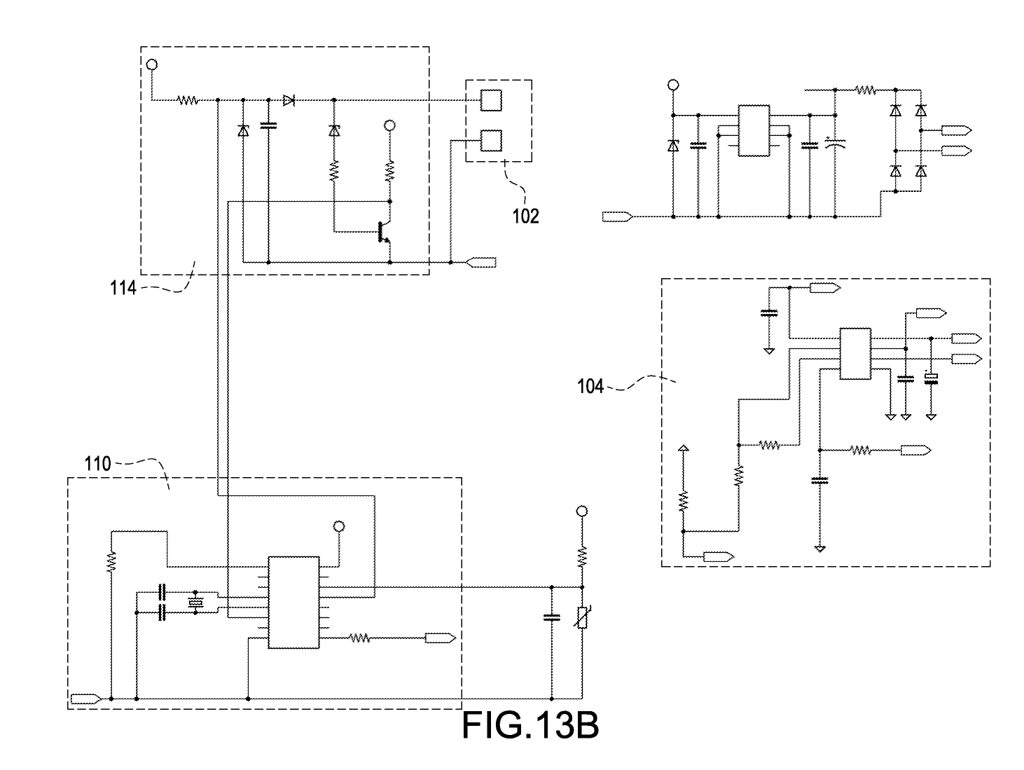

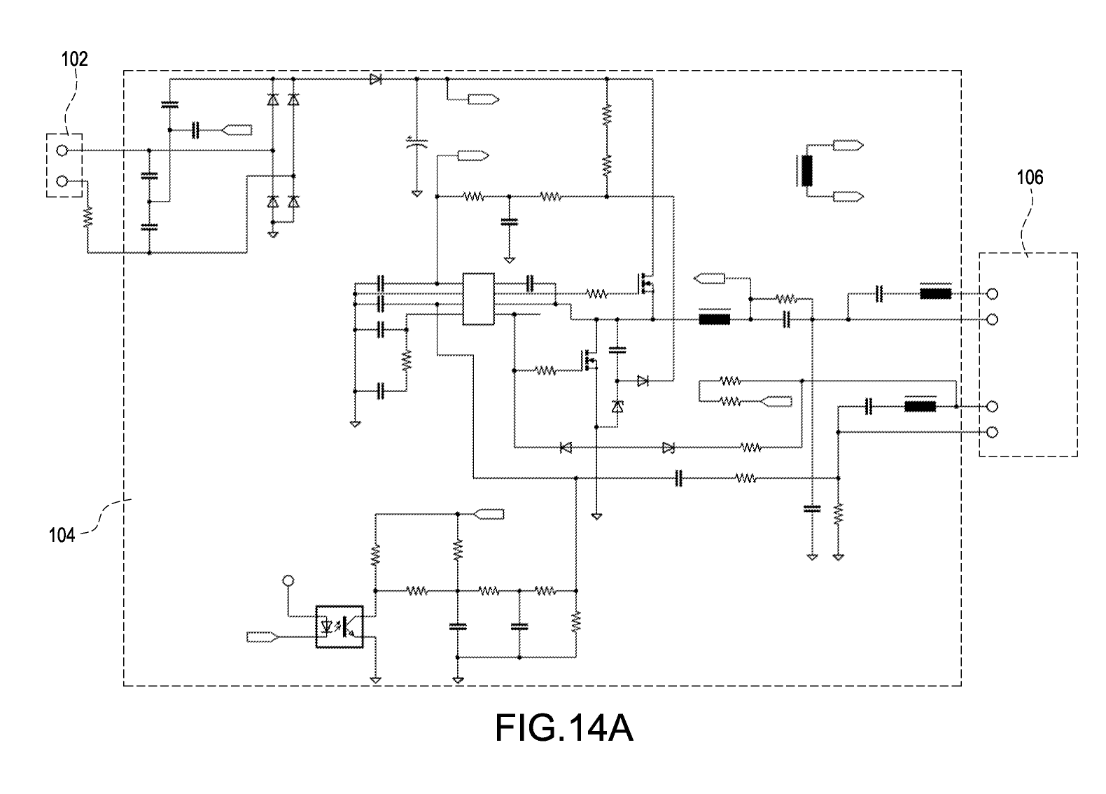

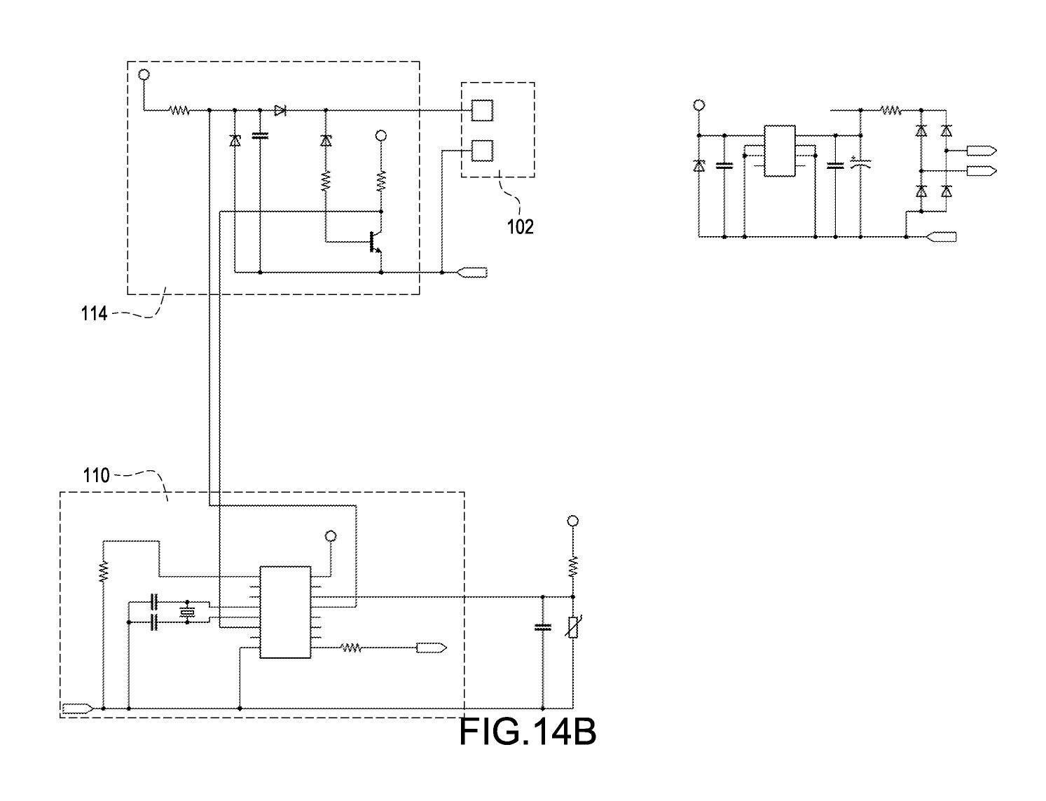

FIG. 13A shows a part of the circuit diagram of an embodiment of the third embodiment applied to light emitting diode lamps of the smart dimmable power supply apparatus for energy saving lamp of the present invention. FIG. 13B shows another part of the circuit diagram of an embodiment of the third embodiment applied to light emitting diode lamps of the smart dimmable power supply apparatus for energy saving lamp of the present invention. FIG. 14A shows a part of the circuit diagram of an embodiment of the third embodiment applied to fluorescent lamps of the smart dimmable power supply apparatus for energy saving lamp of the present invention. FIG. 14B shows another part of the circuit diagram of an embodiment of the third embodiment applied to fluorescent lamps of the smart dimmable power supply apparatus for energy saving lamp of the present invention.

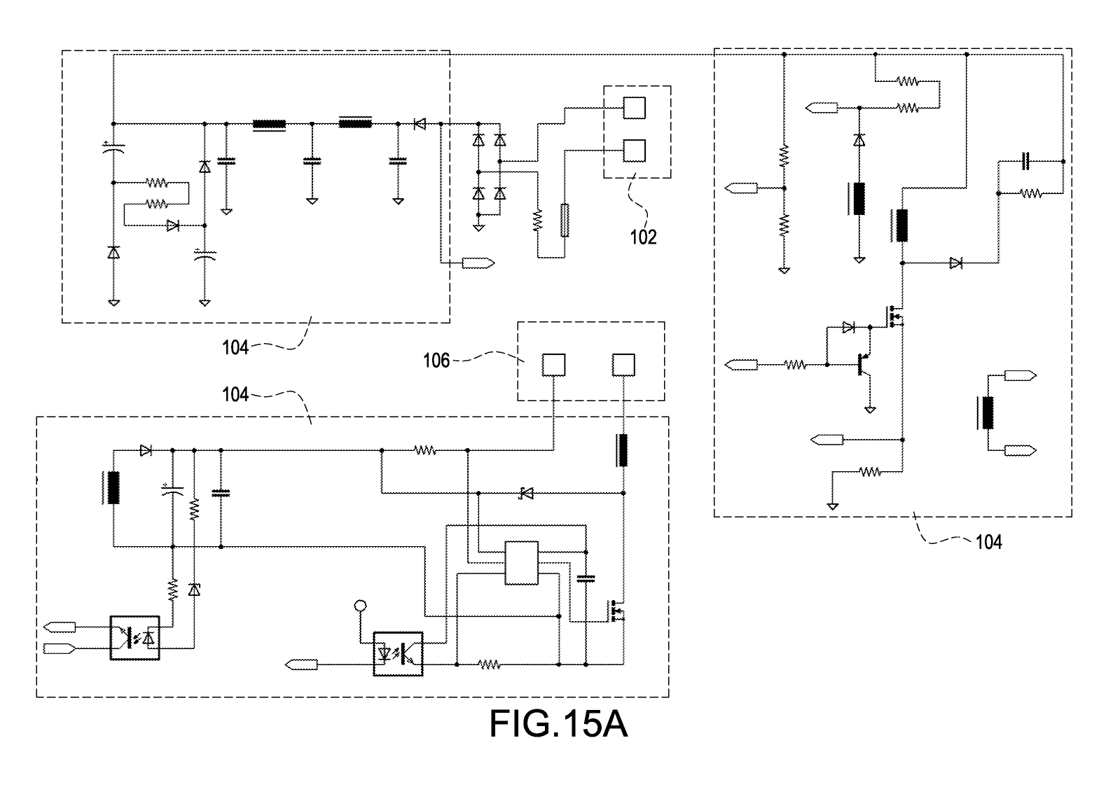

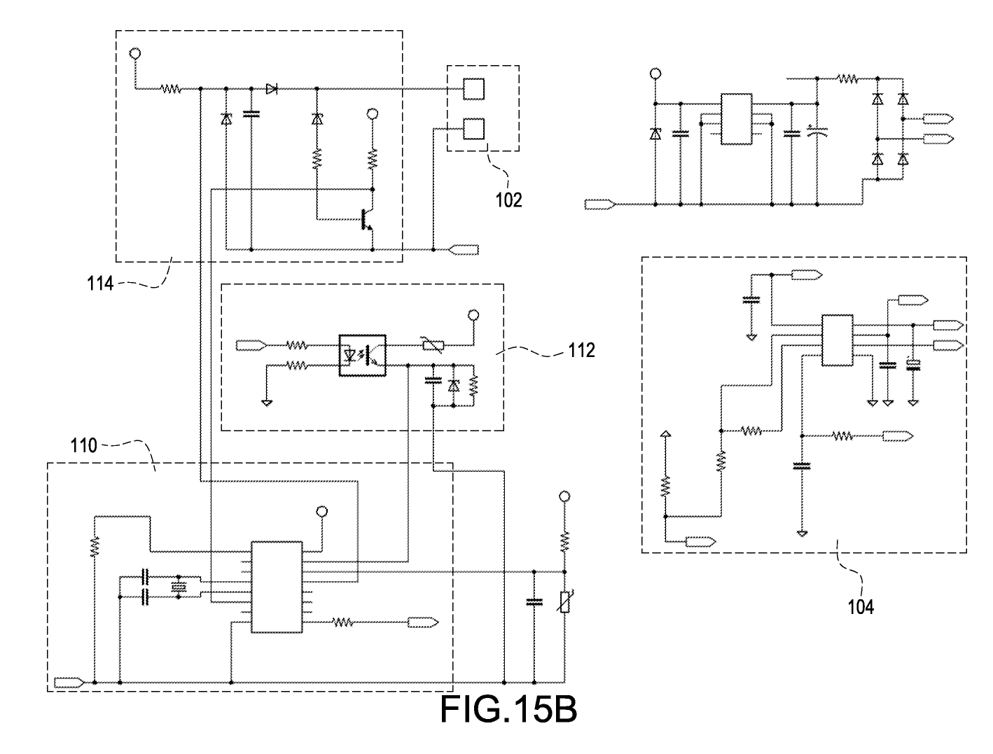

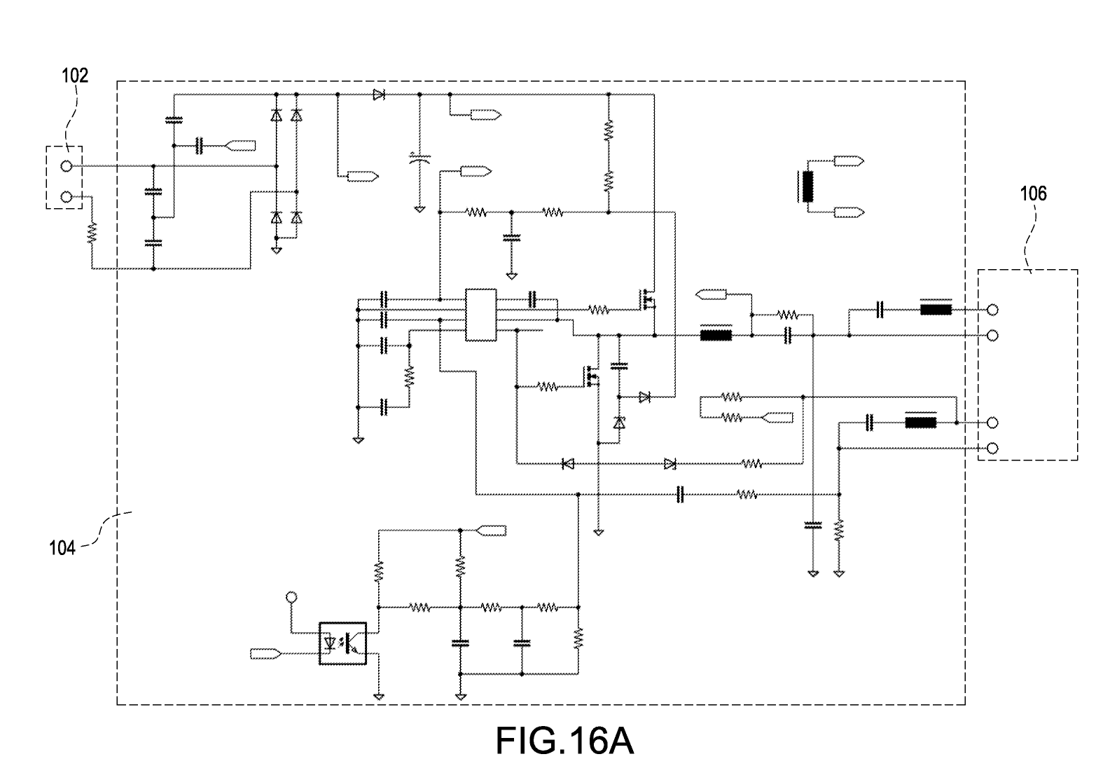

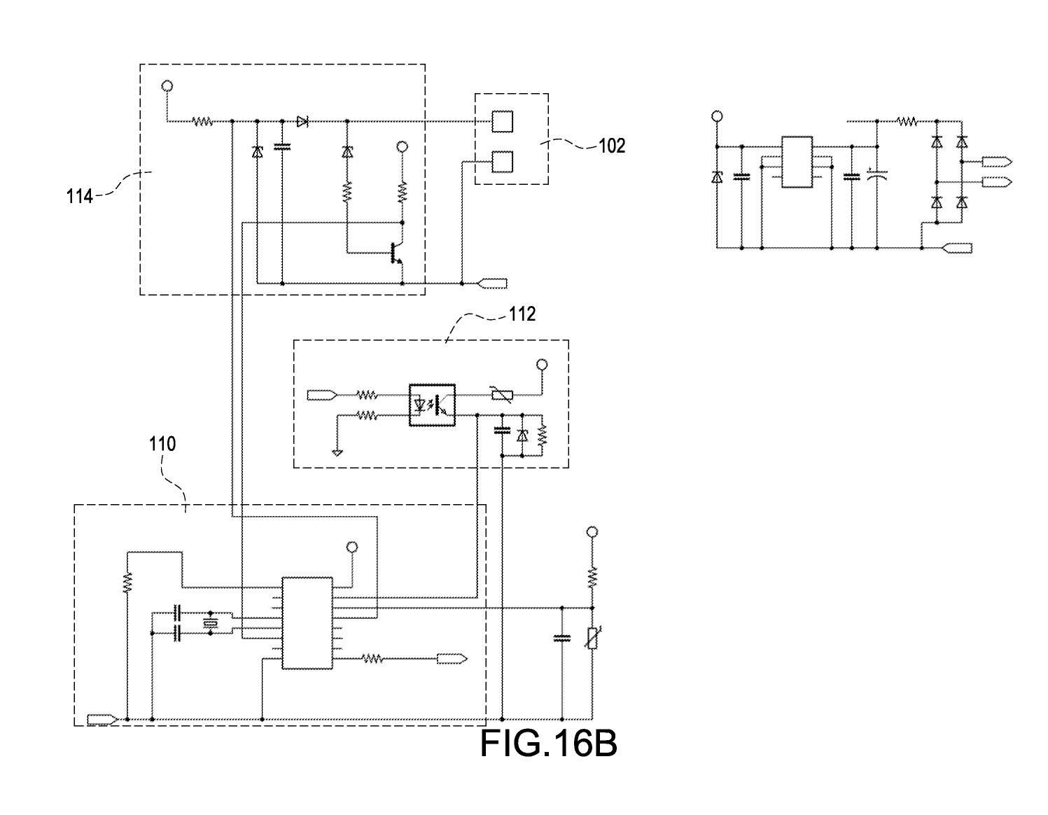

FIG. 15A shows a part of the circuit diagram of an embodiment of the fourth embodiment applied to light emitting diode lamps of the smart dimmable power supply apparatus for energy saving lamp of the present invention. FIG. 15B shows another part of the circuit diagram of an embodiment of the fourth embodiment applied to light emitting diode lamps of the smart dimmable power supply apparatus for energy saving lamp of the present invention. FIG. 16A shows a part of the circuit diagram of an embodiment of the fourth embodiment applied to fluorescent lamps of the smart dimmable power supply apparatus for energy saving lamp of the present invention. FIG. 16B shows another part of the circuit diagram of an embodiment of the fourth embodiment applied to fluorescent lamps of the smart dimmable power supply apparatus for energy saving lamp of the present invention.

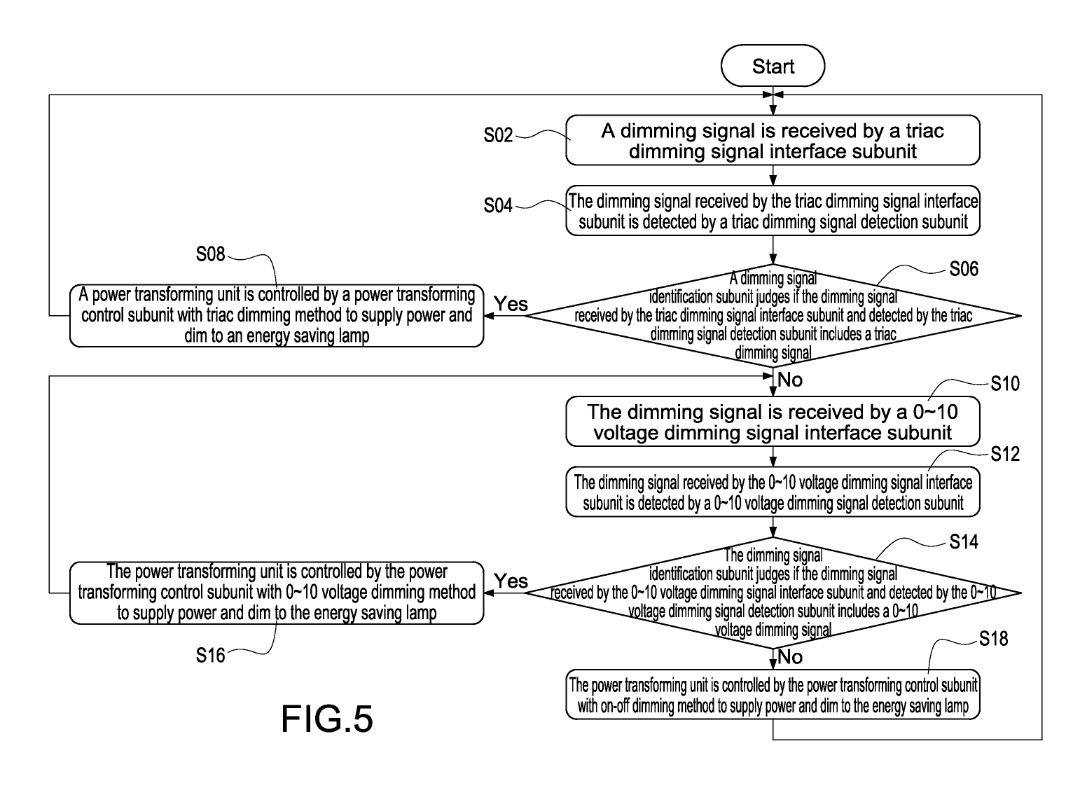

FIG. 5 shows a flow chart of the first embodiment of the smart dimmable power supply method for energy saving lamp of the present invention. The smart dimmable power supply method for energy saving lamp of the present invention includes following steps.

S02: A dimming signal is received by a triac dimming signal interface subunit.

S04: The dimming signal received by the triac dimming signal interface subunit is detected by a triac dimming signal detection subunit.

S06: A dimming signal identification subunit judges if the dimming signal received by the triac dimming signal interface subunit and detected by the triac dimming signal detection subunit includes a triac dimming signal. If yes, goes to step S08. If no, goes to step S10.

S08: A power transforming unit is controlled by a power transforming control subunit with triac dimming method to supply power and dim to an energy saving lamp.

S10: The dimming signal is received by a 0˜10 voltage dimming signal interface subunit.

S12: The dimming signal received by the 0˜10 voltage dimming signal interface subunit is detected by a 0˜10 voltage dimming signal detection subunit.

S14: The dimming signal identification subunit judges if the dimming signal received by the 0˜10 voltage dimming signal interface subunit and detected by the 0˜10 voltage dimming signal detection subunit includes a 0˜10 voltage dimming signal. If yes, goes to step S16. If no, goes to step S18.

S16: The power transforming unit is controlled by the power transforming control subunit with 0˜10 voltage dimming method to supply power and dim to the energy saving lamp.

S18: The power transforming unit is controlled by the power transforming control subunit with on-off dimming method to supply power and dim to the energy saving lamp.

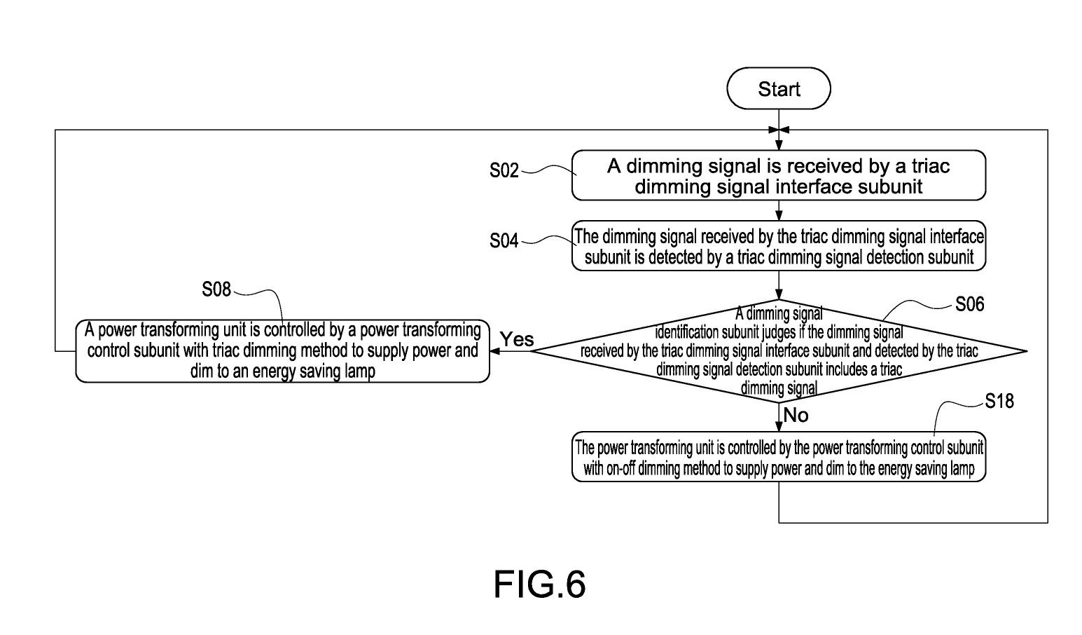

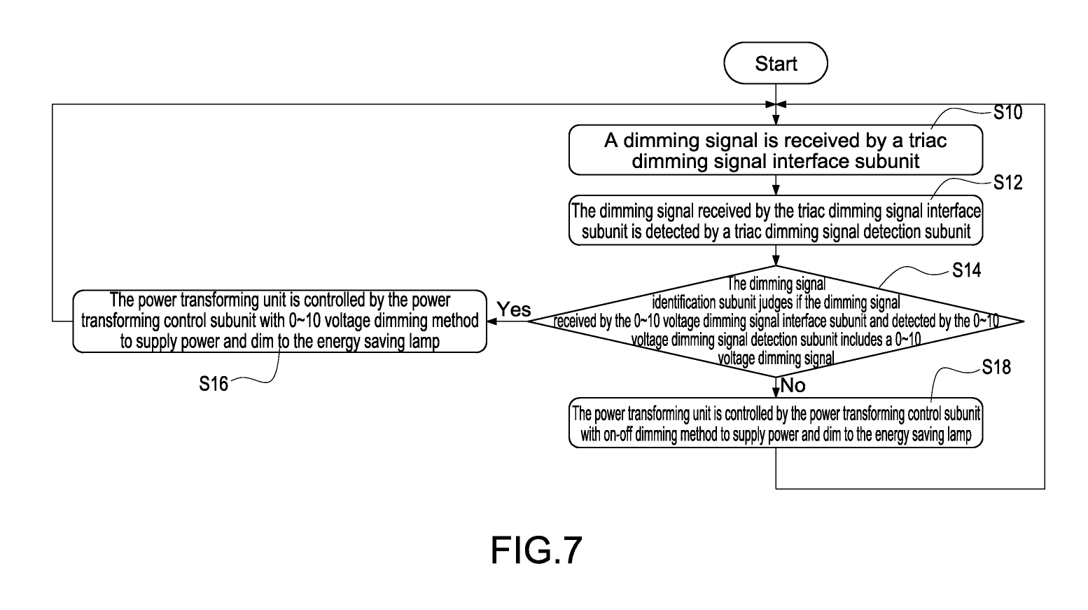

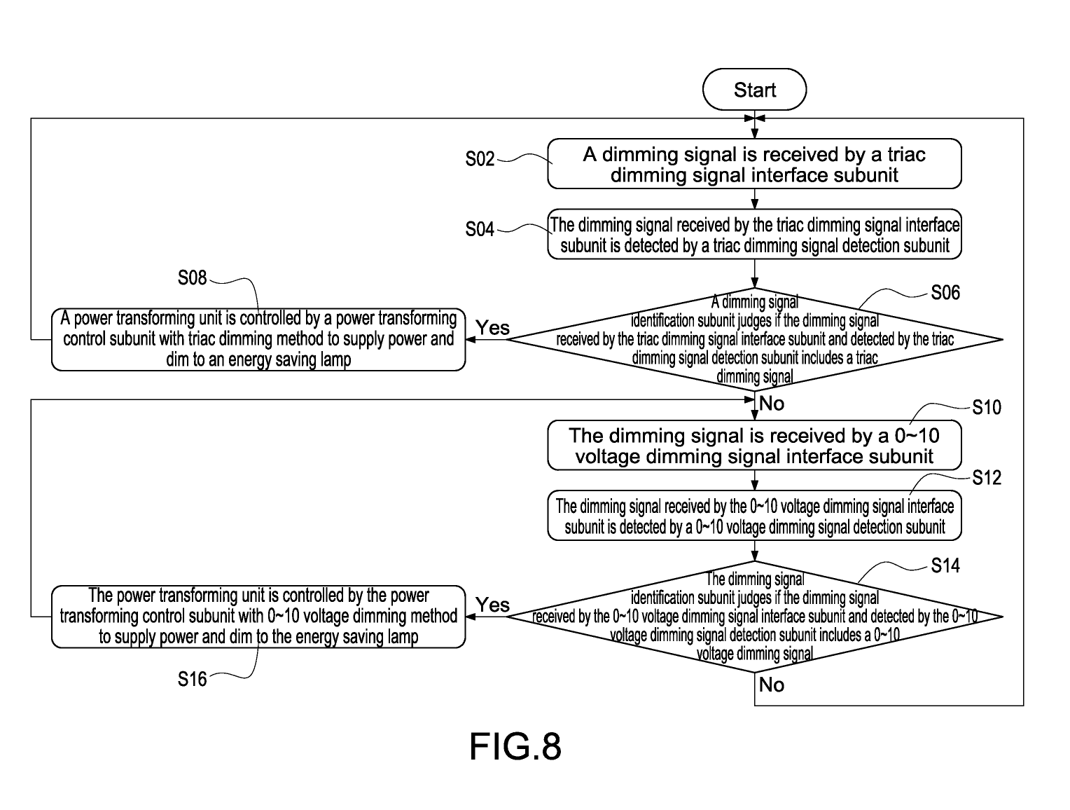

The flow of the first embodiment of the smart dimmable power supply method for energy saving lamp shown in the FIG. 5 is applied to the triac dimming method, the 0˜10 voltage dimming method, and the on-off dimming method. The present invention is able to be applied to only the triac dimming method and the on-off dimming method (as FIG. 6). The present invention is able to be applied to only the 0˜10 voltage dimming method and the on-off dimming method (as FIG. 7). The present invention is able to be applied to only the triac dimming method and the 0˜10 voltage dimming method (as FIG. 8).

FIG. 6 shows a flow chart of the second embodiment of the smart dimmable power supply method for energy saving lamp of the present invention. FIG. 7 shows a flow chart of the third embodiment of the smart dimmable power supply method for energy saving lamp of the present invention. FIG. 8 shows a flow chart of the fourth embodiment of the smart dimmable power supply method for energy saving lamp of the present invention. The flows and principles of the second embodiment shown in the FIG. 6, the third embodiment shown in the FIG. 7, and the fourth embodiment shown in the FIG. 8 are similar to the first embodiment shown in the FIG. 5. The details are omitted here for conciseness.

The smart dimmable power supply apparatus for energy saving lamp and method for the same can automatically detect the kind of the dimmer and dimming method to supply power and dim to an energy saving lamp.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A smart dimmable power supply apparatus for energy saving lamp (10) including:
an input terminal (102);
a power transforming unit (104) electrically connected to the input terminal (102);
a power output terminal (106) electrically connected to the power transforming unit (104);
a dimming signal interface unit (108) electrically connected to the input terminal (102); and
a dimming signal detection identification and power transforming control unit (110) electrically connected to the dimming signal interface unit (108) and the power transforming unit (104),
wherein the dimming signal detection identification and power transforming control unit (110) includes:
a power transforming control subunit (116) electrically connected to the power transforming unit (104);
a dimming signal identification subunit (118) electrically connected to the power transforming control subunit (116);
a first dimming signal detection control subunit electrically connected to the dimming signal identification subunit (118); and
a second dimming signal detection control subunit electrically connected to the dimming signal identification subunit (118).

2. The smart dimmable power supply apparatus for energy saving lamp (10) in claim 1, wherein the dimming signal interface unit (108) includes:
a triac dimming signal interface subunit (112) electrically connected to the input terminal (102); and
a 0˜10 voltage dimming signal interface subunit (114) electrically connected to the input terminal (102),
wherein the first dimming signal detection control subunit is a triac dimming signal detection subunit (120) electrically connected to the dimming signal identification subunit (118) and triac dimming signal interface subunit, wherein the second dimming signal detection control subunit is a 0˜10 voltage dimming signal detection subunit (122) electrically connected to the dimming signal identification subunit (118) and the 0˜10 voltage dimming signal interface subunit (114).

3. The smart dimmable power supply apparatus for energy saving lamp (10) in claim 2, wherein the dimming signal detection identification and power transforming control unit (110) further includes an on-off dimming signal control subunit (124) electrically connected to the dimming signal identification subunit (118).

4. The smart dimmable power supply apparatus for energy saving lamp (10) in claim 1, wherein the dimming signal interface unit (108) includes a triac dimming signal interface subunit (112) electrically connected to the input terminal (102), wherein the first dimming signal detection control subunit is a triac dimming signal detection subunit (120) electrically connected to the dimming signal identification subunit (118) and the triac dimming signal interface subunit (112), wherein the second dimming signal detection control subunit is an on-off dimming signal control subunit (124) electrically connected to the dimming signal identification subunit (118).

5. The smart dimmable power supply apparatus for energy saving lamp (10) in claim 1, wherein the dimming signal interface unit (108) includes a 0˜10 voltage dimming signal interface subunit (114) electrically connected to the input terminal (102), wherein the first dimming signal detection control subunit is a 0˜10 voltage dimming signal detection subunit (122) electrically connected to the dimming signal identification subunit (118) and the 0˜10 voltage dimming signal interface subunit (114), wherein the second dimming signal detection control subunit is an on-off dimming signal control subunit (124) electrically connected to the dimming signal identification subunit (118).

6. A smart dimmable power supply method for energy saving lamp including following steps:
a. receiving a dimming signal by a triac dimming signal interface subunit (112);
b. detecting the dimming signal received by the triac dimming signal interface subunit (112) by a triac dimming signal detection subunit (120);
c. controlling a power transforming unit (104) by a power transforming control subunit (116) with triac dimming method to supply power and dim to an energy saving lamp if the dimming signal received by the triac dimming signal interface subunit (112) and detected by the triac dimming signal detection subunit (120) includes a triac dimming signal judged by a dimming signal identification subunit (118);
d. receiving the dimming signal by a 0˜10 voltage dimming signal interface subunit (114);
e. detecting the dimming signal received by the 0˜10 voltage dimming signal interface subunit (114) by a 0˜10 voltage dimming signal detection subunit (122); and
f. controlling the power transforming unit (104) by the power transforming control subunit (116) with 0˜10 voltage dimming method to supply power and dim to the energy saving lamp if the dimming signal received by the 0˜10 voltage dimming signal interface subunit (114) and detected by the 0˜10 voltage dimming signal detection subunit (122) includes a 0˜10 voltage dimming signal judged by the dimming signal identification subunit (118).

7. The smart dimmable power supply method for energy saving lamp in claim 6, after step f further including:
g. controlling the power transforming unit (104) by the power transforming control subunit (116) with on-off dimming method to supply power and dim to the energy saving lamp if the dimming signal received by the triac dimming signal interface subunit (112) and detected by the triac dimming signal detection subunit (120) does not include the triac dimming signal judged by the dimming signal identification subunit (118), and if the dimming signal received by the 0˜10 voltage dimming signal interface subunit (114) and detected by the 0˜10 voltage dimming signal detection subunit (122) does not include the 0˜10 voltage dimming signal judged by the dimming signal identification subunit (114).

8. A smart dimmable power supply method for energy saving lamp including following steps:
a. receiving a dimming signal by a first dimming signal interface subunit;
b. detecting the dimming signal received by the first dimming signal interface subunit by a first dimming signal detection subunit;
c. controlling a power transforming unit (104) by a power transforming control subunit (116) with first dimming method to supply power and dim to an energy saving lamp if the dimming signal received by the first dimming signal interface subunit and detected by the first dimming signal detection subunit includes a first dimming signal judged by a dimming signal identification subunit (118); and
d. controlling the power transforming unit (104) by the power transforming control subunit (116) with on-off dimming method to supply power and dim to the energy saving lamp if the dimming signal received by the first dimming signal interface subunit and detected by the first dimming signal detection subunit does not include the first dimming signal judged by the dimming signal identification subunit (118).

9. The smart dimmable power supply method for energy saving lamp in claim 8, wherein the first dimming signal interface subunit is a triac dimming signal interface subunit (112), wherein the first dimming signal detection subunit is a triac dimming signal detection subunit (120), wherein the first dimming signal is a triac dimming signal, wherein the first dimming method is triac dimming method.

10. The smart dimmable power supply method for energy saving lamp in claim 8, wherein the first dimming signal interface subunit is a 0˜10 voltage dimming signal interface subunit (114), wherein the first dimming signal detection subunit is a 0˜10 voltage dimming signal detection subunit (122), wherein the first dimming signal is a 0˜10 voltage dimming signal, wherein the first dimming method is 0˜10 voltage dimming method.
